(19) United States
(12) Patent Application Publication
(10) Pub. No.: US 2026/0128658 A1
(43) Pub. Date: May 7, 2026

(54) ELECTROMAGNETIC BRAKE

(71) Applicant: Delta Electronics, Inc., Taoyuan City (TW)

(72) Inventors: Yen-Hung Chen, Taoyuan City (TW); Chia-Chi Lin, Taoyuan City (TW); Yu-Wei Hsu, Taoyuan City (TW); Cheng-Hsun Tsai, Taoyuan City (TW); Cheng-Hang Hou, Taoyuan City (TW); Pao-Feng Lai, Taoyuan City (TW)

(21) Appl. No.: 19/062,646

(22) Filed: Feb. 25, 2025

(30) Foreign Application Priority Data
Nov. 4, 2024 (CN) 202422680019.7

(51) Int. Cl. H02K 49/10

(52) U.S. Cl. CPC H02K 49/10

(57) ABSTRACT

An electromagnetic brake includes a stator and a rotor. The first bottom is connected between one side of the outer ring portion and one side of the inner ring portion. The first ring concave is formed by the outer ring portion, the inner ring portion and the first bottom. The two coils are disposed within the first ring concave. The friction portion is disposed on one side of the outer casing away from the first bottom. The permanent magnet is disposed around the inner friction element, and disposed between the inner friction element and the outer friction element. The rotor is pivotally connected with the stator and includes an armature. The armature is disposed on one side of the friction portion away from the outer casing. The friction portion and the permanent magnet are disposed between the armature and the outer casing.

### CROSS-REFERENCE TO RELATED APPLICATION

This application claims priority to China Patent Application No. 202422680019.7 filed on Nov. 4, 2024, the entire contents of which are incorporated herein by reference for all purposes.

### FIELD OF THE INVENTION

The present invention relates to a brake and more particularly to an electromagnetic brake.

### BACKGROUND OF THE INVENTION

Nowadays, the electromagnetic brake is widely applied to the robotic arms and various types of motors. The electromagnetic brake is an essential component in Industry 4.0. The conventional electromagnetic brake only includes a single coil and a permanent magnet assembled with stamped and turned parts. With the requirement for miniaturization in the robotic arms and various types of the motors, the space for components disposed within the robotic arms and various types of the motors has compressed. Consequently, the electromagnetic brake has demand for reducing the volume and the diameter.

In the restriction of the volume, the braking force produced by the electromagnetic brake is reduced. For enhancing the brake force of the electromagnetic brake, the voltage is enhanced when the electromagnetic brake is activated. When the electromagnetic brake is returned to the original location, the voltage is decreased to the original voltage. When the electromagnetic brake only includes a single coil, the external power supply is essential to control the voltage. Consequently, the number of the control device is increased, and the cost of the electromagnetic brake is increased. When the voltage is increased or decreased, the energy loss is increased.

Therefore, there is a need of providing an electromagnetic brake to obviate the drawbacks encountered from the prior arts.

### SUMMARY OF THE INVENTION

The present disclosure provides an electromagnetic brake. The electromagnetic brake of the present disclosure includes two coils disposed within the first ring concave of the outer casing. The power consumption of the electromagnetic brake is reduced according to the activating of the two coils in different sequence. Moreover, the friction portion of the electromagnetic brake of the present disclosure includes an inner friction element and the outer friction element. The permanent magnet is disposed around the inner friction element, and disposed between the inner friction element and the outer friction element. The friction portion and the permanent magnet are disposed between the armature and the outer casing. According to the above structure, the volume of the outer casing of the electromagnetic brake of the present disclosure is reduced.

In accordance with an aspect of the present disclosure, there is provided an electromagnetic brake. The electromagnetic brake includes a stator and a rotor. The stator includes an outer casing, two coils, a friction portion and a permanent magnet. The outer casing includes an outer ring portion, an inner ring portion, a first bottom and a first ring concave. The outer ring portion is disposed around the inner ring portion. The first bottom is connected between one side of the outer ring portion and one side of the inner ring portion. The first ring concave is formed by the outer ring portion, the inner ring portion and the first bottom collaboratively. The two coils are disposed within the first ring concave. The friction portion is disposed on one side of the outer casing away from the first bottom and includes an inner friction element and an outer friction element. The outer friction element is disposed around the inner friction element. The permanent magnet is disposed around the inner friction element, and disposed between the inner friction element and the outer friction element. The rotor is pivotally connected with the stator and includes an armature. The armature is disposed on one side of the friction portion away from the outer casing. The friction portion and the permanent magnet are disposed between the armature and the outer casing.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating an electromagnetic brake of the present disclosure;

FIG. 2 is a schematic view illustrating a stator and a rotor of the electromagnetic brake as shown in FIG. 1;

FIG. 3 is a schematic cross-sectional view illustrating the electromagnetic brake as shown in FIG. 1;

FIG. 4 is a schematic exploded view illustrating the electromagnetic brake as shown in FIG. 1;

FIG. 5 is a schematic circuit diagram illustrating a brake control circuit controlling the electromagnetic brake as shown in FIG. 1;

FIG. 6 shows operation sequence diagram of the brake control circuit as shown in FIG. 5;

FIG. 7A is a side view illustrating the electromagnetic brake as shown in FIG. 1 when the electromagnetic is not activated; and

FIG. 7B is a side view illustrating the electromagnetic brake as shown in FIG. 1 when the electromagnetic is activated.

### DETAILED DESCRIPTION OF THE PREFERRED EMBODIMENT

The present disclosure will now be described more specifically with reference to the following embodiments. It is to be noted that the following descriptions of preferred embodiments of this invention are presented herein for purpose of illustration and description only. It is not intended to be exhaustive or to be limited to the precise form disclosed.

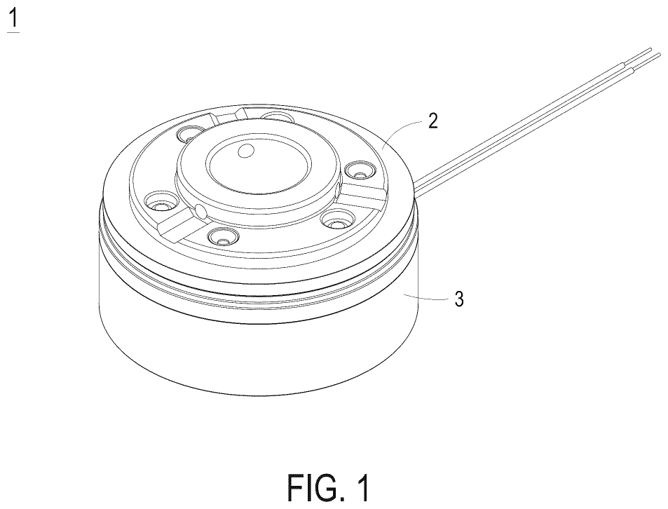

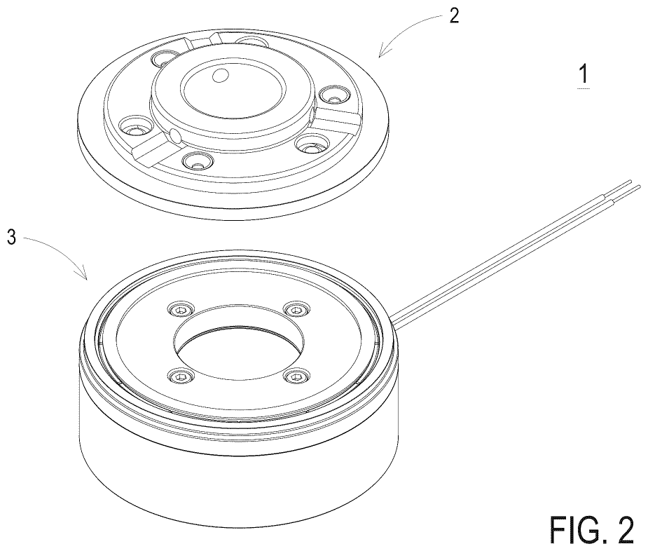

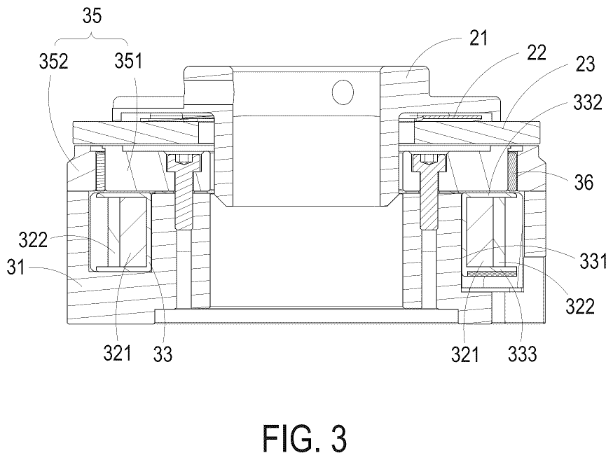

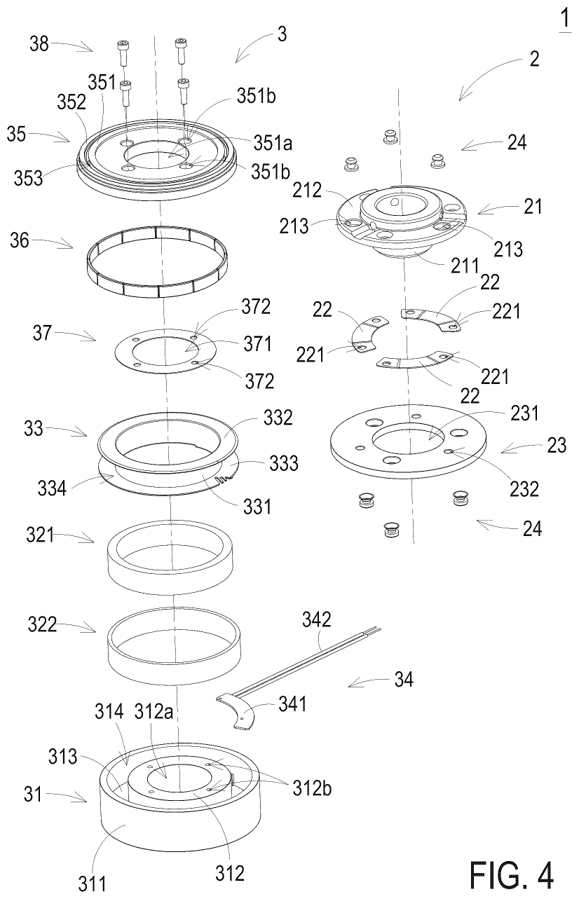

FIG. 1 is a schematic view illustrating an electromagnetic brake of the present disclosure. FIG. 2 is a schematic view illustrating a stator and a rotor of the electromagnetic brake as shown in FIG. 1. FIG. 3 is a schematic cross-sectional view illustrating the electromagnetic brake as shown in FIG. 1. FIG. 4 is a schematic exploded view illustrating the electromagnetic brake as shown in FIG. 1. As shown in FIGS. 1 to 4, the electromagnetic brake 1 of the present disclosure is applied to a robotic arm and a motor. The electromagnetic brake 1 includes a rotor 2 and a stator 3. The rotor 2 includes a rotor hub 21, three springs 22, an armature 23 and three first fixing elements 24. The rotor hub 21 includes a shaft 211, a platform 212 and three first holes 213. The shaft 211 is a cylindrical structure with a hollow portion. The platform 212 is disposed around the outer periphery of the shaft 211. The three first holes 213 are disposed around the shaft 211 separated from each other and run through the platform 212. The three first fixing elements 24 are but not limited to screws or rivets.

The three springs 22 are disposed on one side of the platform 212 of the rotor hub 21 faced to the stator 3. The three springs 22 are disposed around the shaft 211. Each spring 22 includes at least one second hole 221. Each second hole 221 is aligned to the corresponding first hole 213 of the rotor hub 21. The armature 23 is disposed on one side of the platform 212 of the rotor hub 21 faced to the stator 3. The three springs 22 are disposed between the platform 212 of the rotor hub 21 and the armature 23. The armature 23 includes a first receiving portion 231 and three third holes 232. The first receiving portion 231 is disposed in the center of the armature 23 for receiving the shaft 211 of the rotor hub 21. The three third holes 232 are disposed around the first hollow portion 231. Each third hole 232 is aligned to the corresponding first hole 213 and the corresponding second hole 221. Each first fixing element 24 is penetrated through the corresponding first hole 213 of the rotor hub 21, the corresponding second hole 221 of the spring 22 and the corresponding third hole 232 of the armature 23 for fixing the rotor hub 21, the spring 22 and the armature 23 together.

The stator 3 and the rotor 2 are pivotally connected with each other. The stator 3 includes an outer casing 31, a first coil 321, a second coil 322, an inner casing 33, a control element 34, a friction portion 35, a permanent magnet 36, a copper plate 37 and four second fixing element 38. The outer casing 31 includes an outer ring portion 311, an inner ring portion 312, a first bottom 313 and a first ring concave 314. The outer ring portion 311, the inner ring portion 312, the first bottom 313 and the first ring concave 314 are integrally formed into one piece. The outer ring portion 311 is disposed around the inner ring portion 312. The inner ring 312 includes a fourth receiving portion 312a and four sixth holes 312b. The fourth receiving portion 312a is disposed in the center of the inner ring portion 312. The four sixth holes 312b are disposed around the fourth receiving portion 312a. The first bottom 313 is connected with one side of the outer ring portion 311 away from the rotor 2 and one side of the inner ring portion 312 away from the rotor 2. The first ring concave 314 is formed by the outer ring portion 311, the inner ring portion 312 and the first bottom 313 collaboratively. The opening of the first ring concave 314 is toward to the rotor hub 21 of the rotor 2.

The first coil 321 is disposed within the first ring concave 314 of the outer casing 31 and disposed around the inner ring portion 312. The second coil 322 is disposed within the first ring concave 314 of the outer casing 31 and disposed around the inner ring portion 312. The second coil 322 is disposed between the first coil 321 and the outer ring portion 311 of the outer casing 31. The first coil 321 is disposed between the inner ring portion 312 of the outer casing 31 and the second coil 322. The impedance of the second coil 322 is different to the impedance of the first coil 321.

In this embodiment, the inner casing 33 is disposed within the first ring concave 314 of the outer casing 31 and includes a second bottom 331, an upper ring portion 332, a lower ring portion 333 and a second ring concave 334. The second bottom 331 is disposed around the inner ring portion 312 of the outer casing 31. The upper ring portion 332 is extended from one side of the second bottom 331 away from the first bottom 313 toward the outer ring portion 311. The lower ring portion 333 is extended from one side of the second bottom 331 adjacent to the first bottom 313 toward the outer ring portion 311. The second ring concave 334 is formed by the second bottom 331, the upper ring portion 332 and the lower ring portion 333 collaboratively. The opening of the second ring concave 334 is toward the outer ring portion 311 of the outer casing 31. In this embodiment, the first coil 321 and the second coil 322 are disposed within the second ring concave 334 of the inner casing 33. The first coil 321 is disposed between the second ring concave 334 of the inner casing 33 and the second coil 322.

The control element 34 includes a circuit board 341 and a wire 342. The circuit board 341 is disposed within the first ring concave 314 of the outer casing 31, and disposed between the lower ring portion 333 of the inner casing 33 and the first bottom 313 of the outer casing 31. One side of the wire 342 is connected with the circuit board 341. At least portion of the wire 342 is penetrated through the outer ring portion 311 of the outer casing 31 and disposed in the exterior of the outer casing 31. The other side of the wire 342 is connected with an exterior control device (not shown).

The friction portion 35 is disposed on one side of the outer casing 31 away from the first bottom 313, and disposed between the armature 23 and the outer casing 31. As shown in FIG. 3, the friction portion 35 includes an inner friction element 351 and an outer friction element 352. The inner friction element 351 includes a second receiving portion 351a and four fourth holes 351b. The second receiving portion 351a is disposed in the center of the inner friction element 351. The four fourth holes 351b are disposed around the second receiving portion 351a. The outer friction element 352 is disposed around the inner friction element 351. A gap 353 is formed between the outer friction element 352 and the inner friction element 351. The permanent magnet 36 is disposed in the gap 353. The permanent magnet 36 is disposed between the armature 23 and the outer casing 31, as shown in FIG. 3.

The copper plate 37 is disposed between the inner friction element 351 of the friction portion 35 and the inner ring portion 312 of the outer casing 31, and includes a third receiving portion 371 and four fifth holes 372. The third receiving portion 371 is disposed in the center of the copper plate 37, and aligned to the second receiving portion 351a of the inner friction element 351 and the first receiving portion 231 of the armature 23 for receiving the shaft 211 of the rotor hub 21. The four fifth holes 372 are disposed around the third receiving portion 371. Each fifth hole 372 is aligned to the corresponding fourth hole 351b of the inner friction element 351. Each second fixing element 38 is penetrated through the corresponding fourth hole 351b of the inner friction element 351, the corresponding fifth hole 372 of the copper plate 37 and the corresponding sixth hole 312b of the inner ring portion 312 of the outer casing 31, so that the inner friction element 351, the copper plate 37 and the outer casing 31 are fixed together.

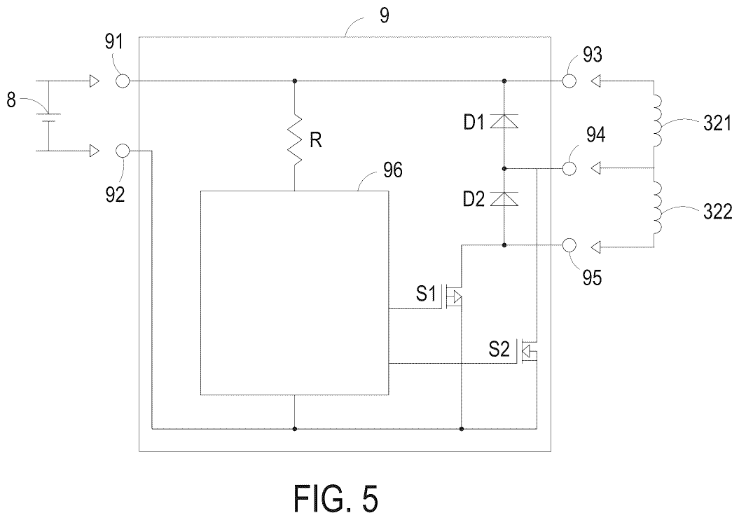

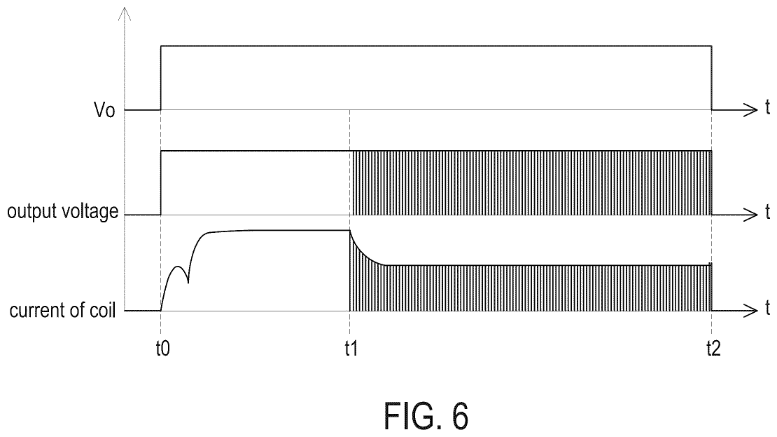

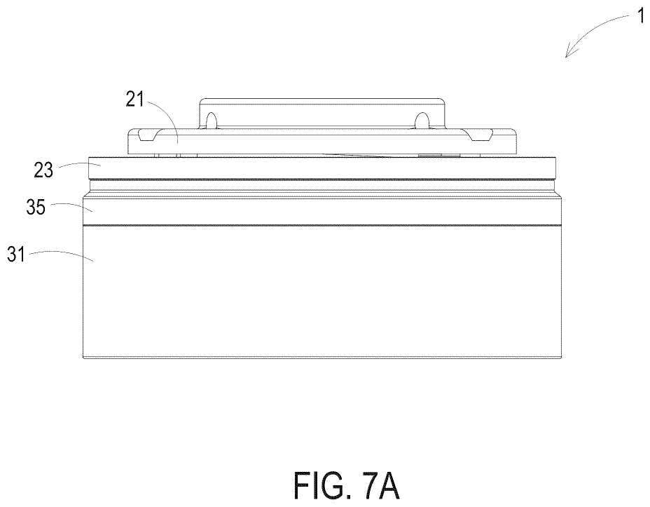

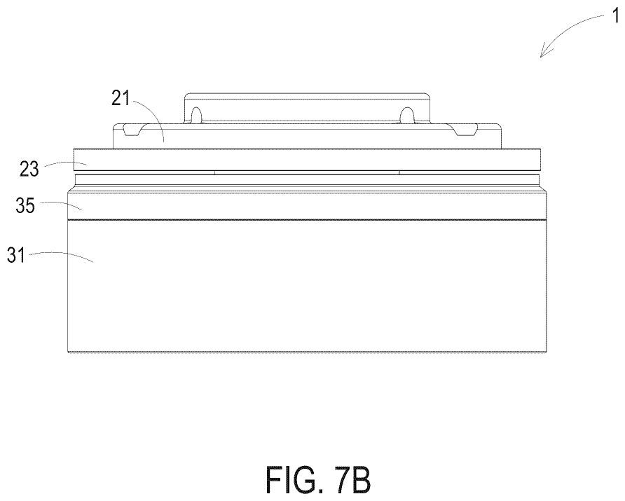

The electromagnetic brake 1 of the present disclosure includes a brake control circuit 9 disposed on the circuit board 341. The brake control circuit 9 includes a RC delay circuit and a PWM circuit. The operation sequence of the two coils (i.e., the first coil 321 and the second coil 322) are controlled through the RC delay circuit and the PWM circuit. FIG. 5 is a schematic circuit diagram illustrating a brake control circuit controlling the electromagnetic brake as shown in FIG. 1. FIG. 6 shows operation sequence diagram of the brake control circuit as shown in FIG. 5. FIG. 7A is a side view illustrating the electromagnetic brake as shown in FIG. 1 when the electromagnetic is not activated. FIG. 7B is a side view illustrating the electromagnetic brake as shown in FIG. 1 when the electromagnetic is activated. As shown in FIG. 5, the brake control circuit 9 of the present disclosure receives a DC voltage Vo provided by the DC power 8. For example, the DC voltage Vo is 24V. The brake control circuit 9 includes a first input terminal 91, a second input terminal 92, a first output terminal 93, a second output terminal 94, a third output terminal 95, a resistor R, a control unit 96, a first transistor S1, a second transistor S2, a first diode D1 and a second diode D2. The brake control circuit 9 receives the DC voltage Vo through the first input terminal 91 and the second input terminal 92, and outputs an output voltage through the first output terminal 93, the second output terminal 94 and the third output terminal 95. The voltage outputted from the second output terminal 94 is referred as a first output voltage. The voltage outputted from the third output terminal 95 is referred as a second output voltage. A first end of the resistor R is connected with the first input terminal 91. The control unit 96 includes a RC delay circuit and a PWM circuit. The control unit 96 is connected between the a second end of the resistor R and the second input terminal 92. The first transistor S1 is a PMOS. A first end of the first transistor S1 is connected with the control unit 96. A second end of the first transistor S1 is connected with the second input terminal 92. A third end of the first transistor S1 is connected with the third output terminal 95. The second transistor S2 is a NMOS. A first end of the second transistor S2 is connected with the control unit 96. A second end of the second transistor S2 is connected with the second input terminal 92. A third end of the second transistor S2 is connected with the second output terminal 94. The cathode of the first diode D1 is connected with the first output terminal 93. The anode of the first diode D1 is connected with the second output terminal 94. The cathode of the second diode D2 is connected with the second output terminal 94. The anode of the second diode D2 is connected with the third output terminal 95. Two sides of the first coil 321 of the electromagnetic brake 1 are connected with the first output terminal 93 and the second output terminal 94, respectively. Two sides of the second coil 322 are connected with the second output terminal 94 and the third output terminal 95, respectively.

When the brake control circuit 9 does not receive any voltage, as shown in FIGS. 4 and 7A, the friction portion 35 of the stator 3 and the armature 23 of the rotor 2 are attracted with each other through the permanent magnet 36 of the stator 3. The armature 23 of the rotor 2 is contacted with the friction portion 35 of the stator 3 so as to activate the brake operation. When the brake control circuit 9 receives the DC voltage Vo provided by the DC power 8 through the first input terminal 91 and the second input terminal 92, the control unit 96 controls the operation of the first transistor S1 and the second transistor S2. As shown in FIG. 6, when the time interval is between t0 and t1 (i.e., the overexcitation time), the control unit 96 controls the first transistor S1 to turn off and the second transistor S2 to turn on. The second output terminal 94 provides the output voltage, so that the current passes through the first coil 321. As shown in FIGS. 4 and 7B, the first coil 321 is activated so as to produce and balance the magnetic field opposite to the magnetic field of the permanent magnet 36. The armature 23 of the rotor 2 is repelled from the permanent magnet 36 disposed within the friction portion 35 of the stator 3. A gap is formed between the armature 23 and the friction portion 35. The brake activation is relieved.

Then, the DC voltage Vo is delayed for few milliseconds through the RC delay circuit of the control unit 96. When the time interval is between t1 and t2 (i.e., the constant excitation time), the control unit 96 controls the first transistor S1 to turn on and the second transistor S2 to turn off, so that the third output terminal 95 provides the output voltage. Consequently, the current passing through the first coil 321 and the second coil 322 to maintain the structure as shown in FIG. 7B. According to the above description, the braking force provided by the first coil 321 is greater than the braking force provided by the first coil 321 and the second coil 322 collaboratively. Consequently, the braking force provided by the first coil 321 is served as the function for releasing the electromagnetic brake 1, and the braking force provided by the first coil 321 and the second coil 322 is served as the function for maintaining the operation of the electromagnetic brake 1 when the electromagnetic brake 1 is released. According to the above control method, at least 40% of the output current is maintained, and the power consumption of the electromagnetic brake 1 is reduced.

As mentioned above, the electromagnetic brake of the present disclosure includes two coils disposed within the first ring concave of the outer casing. The power consumption of the electromagnetic brake is reduced according to the activating of the two coils in different sequence. Moreover, the friction portion of the electromagnetic brake of the present disclosure includes an inner friction element and the outer friction element. The permanent magnet is disposed around the inner friction element, and disposed between the inner friction element and the outer friction element. The friction portion and the permanent magnet are disposed between the armature and the outer casing. According to the above structure, the volume of the outer casing of the electromagnetic brake of the present disclosure is reduced.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An electromagnetic brake, comprising:
a stator, comprising:
an outer casing comprising an outer ring portion, an inner ring portion, a first bottom and a first ring concave, wherein the outer ring portion is disposed around the inner ring portion, the first bottom is connected between one side of the outer ring portion and one side of the inner ring portion, and the first ring concave is formed by the outer ring portion, the inner ring portion and the first bottom collaboratively;
two coils disposed within the first ring concave;
a friction portion disposed on one side of the outer casing away from the first bottom and comprising an inner friction element and an outer friction element, wherein the outer friction element is disposed around the inner friction element; and
a permanent magnet disposed around the inner friction element, and disposed between the inner friction element and the outer friction element; and
a rotor pivotally connected with the stator and comprising:
an armature disposed on one side of the friction portion away from the outer casing, wherein the friction portion and the permanent magnet are disposed between the armature and the outer casing.

2. The electromagnetic brake according to claim 1, wherein the two coils comprises a first coil and a second coil, a first impedance of the first coil is different to a second impedance of the second coil, the second coil is disposed between the first coil and the outer ring portion of the outer casing, and the first coil is disposed between the inner ring portion of the outer casing and the second coil.

3. The electromagnetic brake according to claim 1, wherein the rotor comprises a rotor hub, the rotor hub comprises a shaft, a platform and a plurality of first holes, the platform is disposed around an outer periphery of the shaft, and the plurality of first holes run through the platform and disposed around the shaft.

4. The electromagnetic brake according to claim 3, wherein the rotor comprises a plurality of springs, each of the plurality of springs is disposed between the platform of the rotor hub and the armature and comprises a plurality of second holes, and each of the plurality of second holes is aligned to corresponding one of the plurality of first holes.

5. The electromagnetic brake according to claim 4, wherein the armature comprises a first receiving portion and a plurality of third holes, the first receiving portion is disposed in the center of the armature for receiving the shaft of the rotor hub, the plurality of third holes are disposed around the first receiving portion, and each of the plurality of third holes is aligned to the corresponding one of the plurality of first holes and corresponding one of the plurality of second holes.

6. The electromagnetic brake according to claim 5, wherein the rotor comprises a plurality of first fixing elements, each of the plurality of first fixing elements is penetrated through the corresponding one of the plurality of first holes, the corresponding one of the plurality of second holes and the corresponding one of the plurality of third holes, so that the rotor hub, the plurality of springs and the armature are fixed together.

7. The electromagnetic brake according to claim 1, wherein the stator comprises an inner casing, the inner casing is disposed within the first ring concave of the outer casing and comprises a second bottom, an upper ring portion, a lower ring portion and a second ring concave, the second bottom is disposed around the inner ring portion of the outer casing, the upper ring portion is extended from one side of the second bottom toward the outer ring portion of the outer casing, the lower ring portion is extended from another side of the second bottom toward the outer ring portion of the outer casing, the second ring concave is formed by the second bottom, the upper ring portion and the lower ring portion collaboratively, an opening of the second ring concave is toward the outer ring portion of the outer casing, wherein the two coils are disposed within the second ring concave.

8. The electromagnetic brake according to claim 7, wherein the stator comprise a control element, the control element comprises a circuit board and a wire, wherein the circuit board is disposed within the first ring concave of the outer casing and disposed between the lower ring portion of the inner casing and the first bottom of the outer casing, the wire is connected with the circuit board, and at least portion of the wire is penetrated through the outer ring portion of the outer casing and disposed in the exterior of the outer casing.

9. The electromagnetic brake according to claim 7, wherein the electromagnetic brake comprises a brake control circuit disposed on the circuit board, wherein the brake control circuit comprises a RC delay circuit and a PWM circuit, and an operation sequence of the two coils are controlled through the RC delay circuit and the PWM circuit.

10. The electromagnetic brake according to claim 1, wherein the inner friction element comprises a second receiving portion and a plurality of fourth holes, the second receiving portion is disposed in the center of the inner friction element, and the plurality of fourth holes are disposed around the second receiving portion.

11. The electromagnetic brake according to claim 10, wherein the stator comprises a copper plate, the copper plate is disposed between the inner friction element of the frication portion and the inner ring portion of the outer casing, the copper plate comprises a third receiving portion and a plurality of fifth holes, the third receiving portion is disposed in the center of the copper plate, the third receiving portion is aligned to the second receiving portion and a first receiving portion of the armature, and each of the plurality of fifth holes is aligned to corresponding one of the plurality of fourth holes.

12. The electromagnetic brake according to claim 11, wherein the inner ring portion of the outer casing comprises a fourth receiving portion and a plurality of sixth holes, the fourth receiving portion is disposed in the center of the inner ring portion, the fourth receiving portion is aligned to the second receiving portion, the third receiving portion and the first receiving portion, the plurality of sixth holes are disposed around the fourth receiving portion, each of the plurality of sixth holes is aligned to corresponding one of the plurality of fifth holes and corresponding one of the plurality of fourth holes.

13. The electromagnetic brake according to claim 12, wherein the stator comprises a plurality of second fixing elements, each of the plurality of second fixing elements is penetrated through the corresponding one of the plurality of fourth holes, the corresponding one of the plurality of fifth holes and corresponding one of the plurality of sixth holes.
